(19) United States
(12) Patent Application Publication
(10) Pub. No.: US 2021/0188373 A1
(43) Pub. Date: Jun. 24, 2021

(54) Reducing Aerodynamic Drag of Semi-trailer Truck

(71) Applicant: Jing-Yau Chung, Houston, TX (US)

(72) Inventor: Jing-Yau Chung, Houston, TX (US)

(21) Appl. No.: 17/125,521

(22) Filed: Dec. 17, 2020

Related U.S. Application Data
(60) Provisional application No. 62/949,606, filed on Dec. 18, 2019.

(51) Int. Cl. B62D 35/00

(52) U.S. Cl. CPC B62D 35/001

(57) ABSTRACT

Devices and methodology for reducing the aerodynamic drag of a semi-trailer truck are disclosed. The current devices and methodology reduce the aerodynamic drag by diverting the airflow around the truck resulting in reducing the low pressure or adding pressure to the low pressure in the aerodynamic wake behind the tractor and the trailer.

### TECHNICAL FIELD

The disclosure relates to the field of aerodynamic drag.

### BACKGROUND

It has been well-known that the aerodynamic drag is the major cause of resisting the forward movement of a semi-trailer truck and reducing the aerodynamic drag can significantly improve the fuel economy of the vehicle.

### BRIEF SUMMARY

Devices and methodology for reducing the aerodynamic drag of a semi-trailer truck are disclosed. The current devices and methodology reduce the aerodynamic drag by diverting the airflow around the truck resulting in reducing the low pressure or adding pressure to the low pressure in the aerodynamic wake behind the tractor and the trailer.

### BRIEF DESCRIPTION OF DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a schematic top view of a semi-trailer truck.

FIG. 2 depicts a side elevational view of a semi-trailer truck.

FIG. 3A depicts a sectional view of an embodiment of an air-flow deflector of the disclosure in the form of a conventional flow embodiment.

FIG. 3B depicts a sectional view of an embodiment of an air-flow deflector of the disclosure in the form of a laminar flow embodiment.

FIG. 3C depicts a sectional view of an embodiment of an air-flow deflector of the disclosure in the form of a flat thin piece embodiment.

FIG. 3D depicts a sectional view of an embodiment of an air-flow deflector of the disclosure in the form of a curved flat thin piece embodiment.

FIG. 3E depicts a sectional view of an embodiment of an air-flow deflector of the disclosure in the form of a spoon-shaped embodiment.

### DETAILED DESCRIPTION OF EXEMPLARY EMBODIMENTS

The description that follows includes exemplary apparatus, methods, techniques, and instruction sequences that embody techniques of the inventive subject matter. However, it is understood that the described embodiments may be practiced without these specific details.

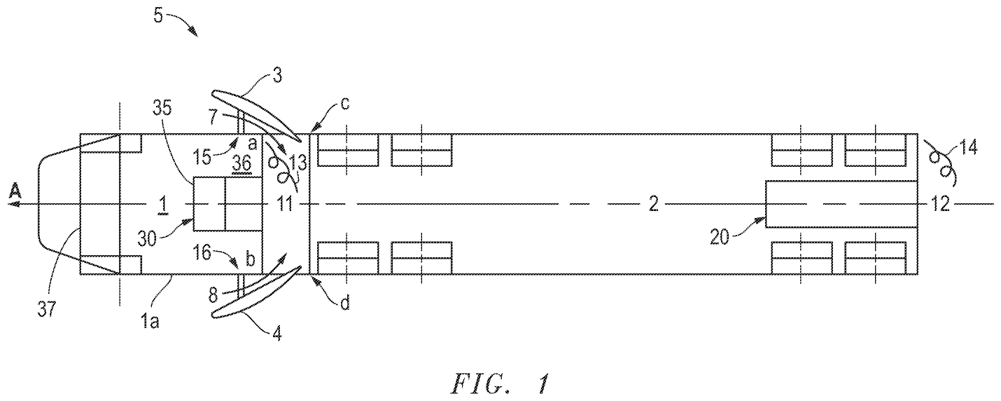

With reference to FIG. 1 which depicts the top view of a semi-trailer truck 5 with tractor 1 and semi-trailer/trailer 2. When the truck is moving in the direction indicated by the arrow A, aerodynamic wake represented at gap 11 and represented at gap 12 are generated respectively behind tractor 1 and trailer 2 which are respectively due to separation of the boundary layer around the tractor 1 and the trailer 2. As depicted in FIG. 1, turbulence 13 and 14 for example are generated inside the aerodynamic wake 11 and 12 respectively which create low pressure zone relative to the non-separated flow field in the boundary layer around the truck 5. The relatively lower pressure in wake 11 and 12 is one of the main causes of the aerodynamic drag in question. Reducing the pressure drop or increasing the pressure in wake 11 and 12 is the subject of this invention. The respective boundary layer of an airfoil, an air deflector, a plate, planar surface, etc. is known to one having ordinary skill in the art of airfoils/air deflectors design.

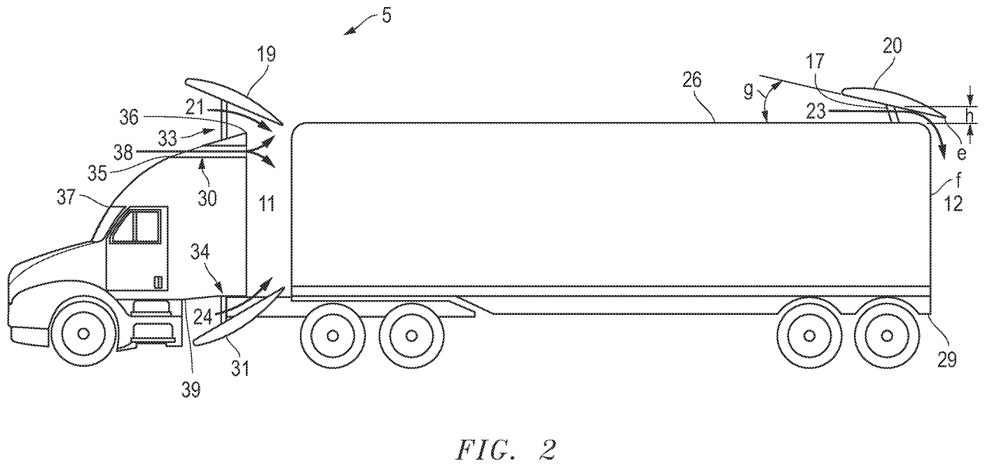

The current invention uses aerodynamic foils, other forms of air deflector e.g. 3, 4, 19, 20, & 31 or air duct e.g. 30 to direct airflow into the aerodynamic wake 11 and 12 to increase the pressure within the wake zone. With reference to FIG. 1, using relatively low-drag airflow deflector, for example, laminar flow airfoils 3 and 4 to direct the airflow 7 and 8 respectively to flow into wake 11 when the truck is moving in direction A. An air duct 30 which has its air-inlet 35 between the tractor 1 windshield 37 and the top of the driver compartment 36, for example, can be used to direct airflow 38 into wake 11 as depicted in FIG. 2. FIG. 2 is the side view of the same semi-trailer truck 5 of FIG. 1. Air duct 30 can be in various configurations. It can be a straight air duct or with orifice or nozzle configurations. The opening of the duct 30 adjacent to wake 11 shall not consist of sharp bending edges which causes flow separation, rather it shall preferably be a gradually enlarged opening to wake 11 to minimize the flow separation thus minimizing the generation of turbulence. As depicted in FIG. 1, airfoil 3 and 4 are attached to the sides of the tractor 1 by means of the airfoil holders/connecting arms 15 and 16 respectively. Airfoil holders 15 and 16 can be adjustable connecting arms that provide the optimum positions of the airfoils 3 and 4 relative to the tractor 1 for the maximum deflected airflow 7 and 8 into wake 11 at any vehicle speed. It should be noted that airfoils 3 and 4 are sectional view of the airfoil 3 and 4 which are, for example, vertical panels attached to the sides 1a of tractor body 1 by means of the adjustable connecting arms 15 and 16 respectively. When airflow 7 and 8 are deflected into wake 11, the aerodynamic drag is reduced due to the increase in pressure in wake 11. The airfoils 3 and 4 can be attached on the leading corners of the trailer 2 at c and d locations respectively.

The airflow deflectors 19, 20, & 31 can also be attached on the top and bottom of the tractor 1 and the trailer 2 as depicted in FIG. 2. The airflow deflector 19 with its connecting arm 33 and airflow deflector 20 with its adjustable/extendable/movable connecting arm 17, for example mounted on the top 36 of the tractor 1 and top 26 the trailer 2 respectively deflect the airflow 21 and 23 into wake 11 and 12 respectively. As an optional positioning of the deflector 20, its end e can be extended beyond the trailing edge f of the trailer 2 when the deflector 20 is in use (i.e. operational mode). When it is not in use, the connecting arm(s) 17 pull(s) the deflector 20 back to its resting position where the deflector 20 is reclining on, abutting, or recessed in/flush with the trailer top 26 and the end e of the deflector 20 does not extend beyond the edge f of the trailer 2 (i.e. resting mode). The deflector 20 can be replaced by an air duct (similar to air duct 30) with various configurations such as a straight duct or an orifice or a nozzle for examples. As depicted in FIG. 2, the airflow deflector 31 with its adjustable/extendable/movable connecting arm 34 attached to the bottom 39 of the tractor 1 deflects the airflow 24 into wake 11. Similarly, an airflow deflector (not shown or represented recessed) can be installed at the rear bottom edge 29 of the trailer 2 to deflect the airflow into wake 12.

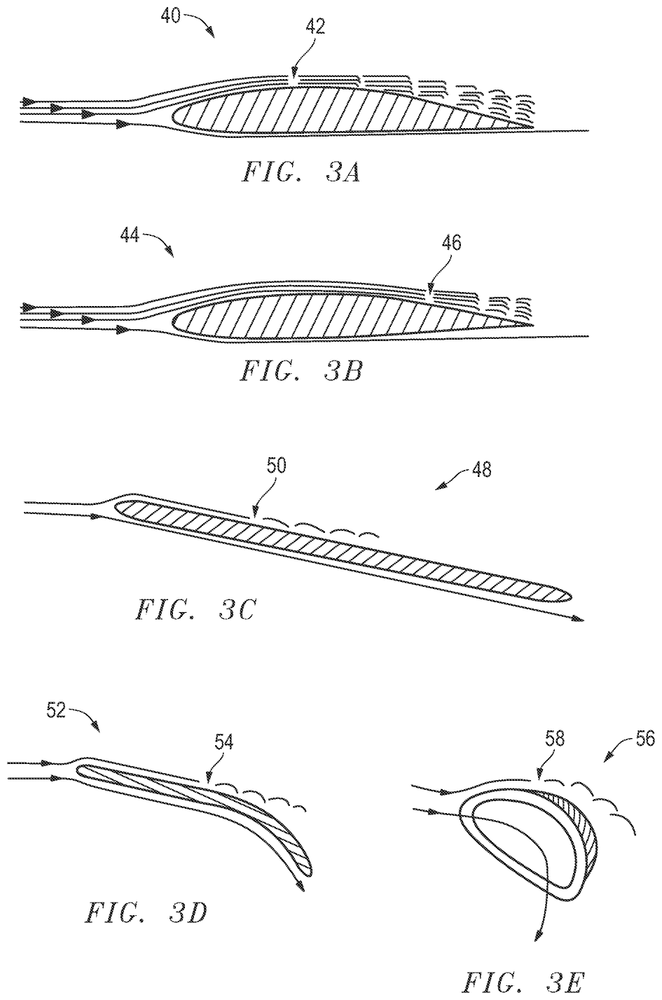

The air-deflectors, e.g. 3, 4, 19, 20, & 31, can be a permanent fixture of the tractor 1 and trailer 2 or it can be a removable attachment to the tractor 1 and trailer 2. If an airfoil design is used as the airflow deflector, it can be in various forms and shapes. For example, it can be a laminar flow airfoil 44 (FIG. 3B showing transition point 46 laminar to turbulent flow), a conventional airfoil 40 (FIG. 3A showing transition point 42 laminar to turbulent flow) or a straight or curved flat thin object, 48 (FIG. 3C showing transition point 50 laminar to turbulent flow) & 52 (FIG. 3D showing transition point 54 laminar to turbulent flow) respectively, as depicted in FIGS. 3A-3D. Other air-deflectors such as a spoon-shaped airflow deflector 56 as depicted in FIG. 3E showing transition point 58 laminar to turbulent flow may be employed. The shape and size of the airflow deflector, e.g. 3, 4, 19, 20, & 31, as well as its location relative to the tractor 1 or trailer 2 are chosen to minimize the drag generated by the respective airflow deflector itself and to maximize the airflow deflection into the respective wake 11 and 12. The adjustable/extendable connecting arms 15, 16, 17, 33 and 34 are designed to provide various angles of attack of the airflow deflectors, e.g. 3, 4, 19, 20, & 31, which are attached to the connecting arms 15, 16, 17, 33 and 34 by means of hinges or the like. The said connecting arms 15, 16, 17, 33 and 34 are designed to pull the respective airflow deflectors 3, 4, 20, 19 and 31 to be closely attached to, abutting, or recessed in/flush (see FIG. 1 representing various individual airflow deflectors recessed) with the tractor 1 or trailer 2 bodies as their resting positions when the deflectors are not in use as known to one having ordinary skill in the art. The connecting arms 15, 16, 17, 33 and 34 also provide various angles of attack g (one represented in FIG. 2, but it is to be understood that it is applicable to all deflectors) and various distances h (one represented in FIG. 2, but it is to be understood that it is applicable to all deflectors) between the respective deflectors 3, 4, 20, 19 and 31 and the truck 1 and trailer 2 bodies such that the deflectors 3, 4, 20, 19 and 31 generate maximum flow deflection into respective wakes 11 and 12. The abovementioned choice of the respective angle of attack g and the respective distance h from the truck 1 and trailer 2 body can be achieved by manual means or by automatic control in which feed-back control may be used to determine the optimum parameters for the maximum air flow (volume) deflection with respect to a given truck speed and yaw angle between the truck moving direction and the head wing/wind.

The parameters and value for the variable distance h and the variable angle of attack g are dependent upon several factors. The distance h is such that the respective deflector 3, 4, 20, 19 and/or 31 shall be in the “free stream” region outside the boundary layer which is very close to the surface of the semi-trailer truck 5 body at high speed. At low vehicle speed, the respective deflector 3, 4, 20, 19 and/or 31 may never be in the free stream region (the use of the deflector at low vehicle speed lesser interest). The angle of attack g is dependent, at least in part, to the “drag-to-lift-ratio” which is preferably as small as possible while the respective deflector 3, 4, 20, 19 and/or 31 is functioning in accordance with the purpose of deflecting the volume of air flow. The deflection of flow is larger with larger angle of attack g whilst the drag-to lift-ratio increases with larger angle of attack g. Therefore selection of the optimal angle of attack g is dependent at least in part on a given semi-trailer truck 5 speed for purposes of achieving the maximum flow deflection at minimum drag-to-lift-ratio.

The criteria for the length and size of each aerodynamic airfoil, or other objects as airflow deflector(s) 3, 4, 20, 19 and 31 is determined/selected to reach the optimum airflow deflection into the wakes 11, 12. For example, if the length of an airflow deflector 3, 4, 20, 19 and 31 is sufficiently long, such that it extends into the free stream region or near the free stream region outside the boundary layer around the tractor 1 and trailer 2, then it shall be an effective airflow deflector 3, 4, 20, 19 and 31.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An apparatus for reducing an aerodynamic drag of a semi-trailer truck wherein a gap is defined between a tractor and a semi-trailer and an aerodynamic wake is generated in the gap and behind the semi-trailer wherein the aerodynamic wake creates a region of low pressure in the gap, comprising:
a means for adding pressure to the low pressure in the aerodynamic wake mounted on the semi-trailer truck.

2. The apparatus for reducing the aerodynamic drag of the semi-trailer truck according to claim 1, wherein said means for adding pressure to the low pressure in the aerodynamic wake comprises at least two arms one each connected to opposites sides of the tractor;
at least two air deflectors respectively connected to each of the arms;
wherein a longitudinal axis of each of the air deflectors is vertical when connected to the arms; and
wherein each of the air deflectors is disposed/arranged to direct maximum flow into the wake for adding air pressure to the lower air pressure in the aerodynamic wake.

3. The apparatus for reducing the aerodynamic drag of the semi-trailer truck according to claim 1, wherein said means for adding pressure to the low pressure in the aerodynamic wake comprises the tractor defining an air duct which has an air-inlet between a windshield and a top of a driver compartment of the tractor.

4. The apparatus for reducing the aerodynamic drag of the semi-trailer truck according to claim 1, wherein the disposed arrangement to direct maximum flow into the wake comprises an adjustable angle of attack of each of the air deflectors.

5. The apparatus for reducing the aerodynamic drag of the semi-trailer truck according to claim 4, wherein the disposed arrangement to direct maximum flow into the wake comprises an adjustable distance between each of the air deflectors.

6. The apparatus for reducing the aerodynamic drag of the semi-trailer truck according to claim 1, wherein the disposed arrangement to direct maximum flow into the wake comprises an adjustable distance between each of the air deflectors.

7. The apparatus for reducing the aerodynamic drag of the semi-trailer truck according to each of the claim 1, wherein said means for adding pressure to the low pressure in the aerodynamic wake comprises a plurality of air deflectors wherein each of the air deflectors is an aerodynamic foil with minimum drag to lift ratio at the operational angle of attack.

8. The apparatus for reducing the aerodynamic drag of the semi-trailer truck according to each of the claim 1, wherein said means for adding pressure to the low pressure in the aerodynamic wake comprises a plurality of air deflectors wherein each of the air deflectors is a spoon-shaped object.

9. The apparatus for reducing the aerodynamic drag of the semi-trailer truck according to each of the claim 1, further comprising two airfoils mounted respectively on a top of the tractor and a top of the semi-trailer for directing the airflow into the wakes.

10. The apparatus for reducing the aerodynamic drag of the semi-trailer truck according to each of the claim 1, further comprising two additional air deflectors connected on a respective leading-side corner of the semi-trailer.

11. The apparatus for reducing the aerodynamic drag of the semi-trailer truck according to claim 1, wherein said means for adding pressure to the low pressure in the aerodynamic wake comprises another arm connected to a top of the tractor;
A top air deflector respectively connected to the top arm;
wherein a longitudinal axis of the top air deflector is horizontal when connected to the top arm; and wherein the top air deflector is disposed/arranged to direct maximum flow into the wake for adding air pressure to the lower air pressure in the aerodynamic wake.

12. The apparatus for reducing the aerodynamic drag of the semi-trailer truck according to claim 1, wherein said means for adding pressure to the low pressure in the aerodynamic wake comprises another arm connected to a bottom of the tractor;
a bottom air deflector respectively connected to the bottom arm;
wherein a longitudinal axis of the bottom air deflector is horizontal when connected to the bottom arm; and wherein the bottom air deflector is disposed/arranged to direct maximum flow into the wake for adding air pressure to the lower air pressure in the aerodynamic wake.

13. The apparatus for reducing the aerodynamic drag of the semi-trailer truck according to claim 1, wherein said means for adding pressure to the low pressure in the aerodynamic wake comprises another arm connected to a top back end of the semi-trailer;
a top back air deflector respectively connected to the top arm; and
wherein a longitudinal axis of the top back air deflector is horizontal when connected to the top arm; and wherein the top back air deflector is disposed/arranged to direct maximum flow into the wake for adding air pressure to the lower air pressure in the aerodynamic wake.

14. An apparatus for reducing an aerodynamic drag of a semi-trailer truck wherein a gap is defined between a tractor and a semi-trailer and an aerodynamic wake is generated in the gap and behind the semi-trailer wherein the aerodynamic wake creates a region of low pressure in the gap, comprising:
at least two arms one each connected to opposite sides of the tractor;
at least two air deflectors respectively connected to each of the arms;
wherein a longitudinal axis of each of the air deflectors is vertical when connected to the arms;
another arm connected to a top of the tractor;
a top air deflector respectively connected to the top arm;
wherein a longitudinal axis of the top air deflector is horizontal when connected to the top arm; and wherein the top air deflector is disposed/arranged to direct maximum flow into the wake for adding air pressure to the lower air pressure in the aerodynamic wake;
another arm connected to a bottom of the tractor;
a bottom air deflector respectively connected to the bottom arm;
wherein a longitudinal axis of the bottom air deflector is horizontal when connected to the bottom arm; and wherein the bottom air deflector is disposed/arranged to direct maximum flow into the wake for adding air pressure to the lower air pressure in the aerodynamic wake;
wherein each of said air deflectors is disposed to direct maximum flow into the wake for adding air pressure to the lower air pressure in the aerodynamic wake;
the tractor defining an air duct which has an air-inlet between a windshield and a top of a driver compartment of the tractor;
another arm connected to a top back end of the semi-trailer;
a top back air deflector respectively connected to the top back end arm; and
wherein a longitudinal axis of the top back air deflector is horizontal when connected to the top back end arm; and wherein the top back air deflector is disposed to direct maximum flow into the wake for adding air pressure to the lower air pressure in the aerodynamic wake;
wherein the disposed arrangement to direct maximum flow into the wake comprises an adjustable distance between each of the respective air deflectors;
wherein the disposed arrangement to direct maximum flow into the wake comprises an adjustable angle of attack of each of the respective air deflectors; and
wherein each of the air deflectors is an aerodynamic foil with minimum drag to lift ratio at the operational angle of attack.

15. A method for reducing an aerodynamic drag of a semi-trailer truck wherein a gap is defined between a tractor and a semi-trailer and aerodynamic wakes are generated in the gap and behind the semi-trailer, comprising the step of adding air pressure to a lower air pressure in each of the aerodynamic wakes.
